(19) United States
(12) Patent Application Publication
(10) Pub. No.: US 2026/0288472 A1
(43) Pub. Date: Sep. 24, 2026

(54) SYSTEMS AND METHODS FOR ENHANCED MEMORY CLEANUP OPERATIONS

(71) Applicant: QUALCOMM Incorporated, San Diego, CA (US)

(72) Inventors: Nileshkumar Chandrakantbhai Motawala, Surat (IN); Amol Upreti, Lalitpur (IN); Murali Krishna Sannidi, Visakhapatnam (IN); Subham Panda, Balasore (IN); Radhakrishna Mugada, Hyderabad (IN)

(21) Appl. No.: 19/084,216

(22) Filed: Mar. 19, 2025

(51) Int. Cl. G06F 9/4401

(52) U.S. Cl. CPC G06F 9/4401

(57) ABSTRACT

This disclosure provides systems, methods, and devices that support enhanced memory cleaning operations. In a first aspect, a system-on-a-chip (SoC) includes at least one processor and at least one memory coupled to the at least one processor. The at least one processor is configured to cause the SoC to: interrupt a direct memory access (DMA) engine to perform a memory restoration operation on a memory associated with the DMA engine; perform, by a first processor thread, wake-up task operations and quick boot notification operations for a subsystem associated with the memory; perform, by a second processor thread, the memory restoration operation on the memory in parallel with one or more of the wake-up task operations or quick boot notification operations; and perform run time initialization operations for the subsystem based on completion of the wake-up or quick boot operations. Other aspects and features are also claimed and described.

### TECHNICAL FIELD

Aspects of the present disclosure relate generally to an apparatus and method for enhanced memory restoration operations. Some aspects may, more particularly, relate to enhanced memory restoration operations for cache and tightly coupled memory, including leveraging parallelization, such as for restoring memory operation after boot and wake-up operations.

### INTRODUCTION

System-on-a-chip (SoC) designs and mobile devices are becoming more complex, implementing smaller physical profiles with ever-decreasing conductor path dimensions for transferring data at higher rates than predecessor SoCs. Operating at higher speeds with greater physical design constraints may increase power demands.

Mobile devices are capable of running complex software applications and often have multiple wireless access technologies for communicating voice and data using both short-range and long-range wireless systems. With this size reduction and substantial increase in processing power and memory, the power demand for new mobile devices is ever increasing. Additionally, the push for miniaturization drives down the size of batteries to fit in more smaller and complex devices. Thus, battery life and power management are an important aspect to continue to advance mobile innovation.

Several power saving mechanisms have been proposed to extend battery life in mobile devices, such as in single-chip SoCs. One such method that has been implemented is the use of sleep or idle modes in the mobile device. For example, when a device is not currently engaging in wireless communications or not performing processing activities, one or more components of the SoC may be put to sleep to conserve power. However, putting components to sleep requires coordination across multiple components of the SoC, which can create challenges for meeting wake-up demands, such as to quickly restoring power to the components for future operations and ensuring that the corresponding memory or memories are available and maintain data integrity.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects disclosed herein describe enhanced systems, methods, and devices for enhanced memory restoration operations. The enhanced memory restoration operations enable coordination and parallelization of wake-up task operations and memory clean-up and initialization operations across multiple threads of a processor of a SoC to enable reduced wake-up times for components of the SoC and improved responsiveness and safety performance.

In one aspect of the disclosure, a system-on-chip (SoC) includes at least one processor and at least one memory coupled to the at least one processor. The at least one processor is configured to cause the SoC to: interrupt a direct memory access engine to perform a memory restoration operation on a memory associated with the direct memory access engine; perform, by a first processor thread of a processor of the at least one processor, wake-up task operations and quick boot notification operations for a subsystem associated with the memory; perform, by a second processor thread of the processor, the memory restoration operation on the memory in parallel with one or more of the wake-up task operations or quick boot notification operations; and perform run time initialization operations for the subsystem based on completion of the one or more of the wake-up task operations or quick boot notification operation.

In another aspect, method for enhanced deep sleep for a system-on-chip (SoC) includes: interrupting a direct memory access engine to perform a memory restoration operation on a memory associated with the direct memory access engine; performing, by a first processor thread of a processor of the SoC, wake-up task operations and quick boot notification operations for a subsystem associated with the memory; performing, by a second processor thread of the processor, the memory restoration operation on the memory in parallel with one or more of the wake-up task operations or quick boot notification operations; and performing run time initialization operations for the subsystem based on completion of the one or more of the wake-up task operations or quick boot notification operation.

In an additional aspect, a system-on-chip (SoC) includes at least one processor and at least one coupled to the at least one processor. The at least one processor is configured to cause the SoC to: transmit, by a first processor thread of a processor of the at least one processor to a second processor thread of the processor, a direct memory start indication that indications for a direct memory access engine to perform a memory restoration operation on a memory associated with the direct memory access engine; perform, by the first processor thread, wake-up task operations for a subsystem associated with the memory; perform, by the first processor thread, quick boot notification operations for the subsystem; transmit, by the first processor thread to the second processor thread, a direct memory poll request that requests a status of the memory restoration operation; receive, by the first processor thread from the second processor thread, a direct memory poll request response indicating completion of the memory restoration operation; and perform run time initialization operations in parallel with the memory restoration operation.

In another additional aspect, a system-on-chip (SoC) includes at least one processor and at least one coupled to the at least one processor. The at least one processor is configured to cause the SoC to: receive, by a first processor thread from a second processor thread, a direct memory start indication that indications for a direct memory access engine to perform a memory restoration operation; perform, by the first processor thread, the memory restoration operation; receive, by the first processor thread from the second processor thread, a direct memory poll request that requests a status of the memory restoration operation; and transmit, by the first processor thread to the second processor thread, a direct memory poll request response indicating completion of the memory restoration operation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a system including a computing device according to some aspects of the disclosure.

FIG. 2 is a flow diagram illustrating an example of enhanced memory restoration operations for multiple chip SoCs according to some aspects of the disclosure.

FIG. 3 is a block diagram illustrating an example of a system-on-chip (SoC) architecture according to some aspects of the disclosure.

FIG. 4 is a flow diagram illustrating an example of enhanced memory restoration operations according to some aspects of the disclosure.

FIG. 5 is a flow diagram illustrating another example of enhanced memory restoration operations according to some aspects of the disclosure.

FIG. 6 is a flow diagram illustrating another example of enhanced memory restoration operations according to some aspects of the disclosure.

FIG. 7 is a flow chart illustrating a method for enhanced memory restoration operations according to some aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

The term “system-on-a-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

As used herein, the term “computing device” refers to any one or all of vehicle management systems, display sub-systems, driver assistance systems, vehicle controllers, vehicle system controllers, vehicle communication system, infotainment systems, vehicle display systems or subsystems, vehicle data controllers or routers, cellular telephones, smart phones, personal or mobile multi-media players, personal data assistants (PDAs), laptop computers, personal computers, tablet computers, smart books, palm-top computers, wireless electronic mail receivers, multimedia Internet enabled cellular telephones, vehicle controllers, and similar electronic devices which include a programmable processor and memory and circuitry configured to perform operations as described herein.

As used herein, the term “flip flop” refers to a circuit that has two stable states and can be used to store state information. A flip flop may include at least two logic gates to perform storage functions. A group of at least two flip flops in a series configuration may be used as a shift register to shift state information bit by bit serially through the flip flops. In some embodiments, a flip flop may be referred to as a latch.

As used herein, the term “spatially” may refer to the physical orientation and/or location of a system component or area within the physical layout and stack-up or a computing device. For example, a group of flip flops may be referred to as being spatially associated with a grid portion of an SoC, where an SoC is logically divided into various portions with respect to the SoC physical layout and/or stack-up. A group of flip flops may be spatially associated with a grid portion such that the group of flips flops may be physically located within the logical boundaries of the grid portion. As another example, a group of flip flops, or a group of logic gates, may be spatially associated with a scan chain section, and therefore the scan chain section may be spatially associated with a corresponding grid portion that is spatially associated with the group of flip flops.

As used herein, the term “grid portion” refers to a physical portion of an SoC in three-dimensional space. For example, a grid portion may be a volume of an SoC fabrication, in which the grid portion is distinct from other grid portions as arranged in a top-down view of the SoC fabrication. A grid portion may include one or more SoC stacks or layers, or a portion of one or more stacks or layers within an SoC. In some embodiments, a grid portion may be referred to as a region of an SoC. In some embodiments, a portion of the SoC may not be a grid portion, but may be a physical portion of the SoC having a defined volume and/or shape distinct from a grid configuration. For example, a portion of the SoC may be dimensionally rectangular, or may be any other shape and volume as determined in a design stage of an SoC. Thus, an SoC may be logically divided into any number of portions, or regions, each having any variety of volumes, such that a single SoC may be logically divided into at least two portions.

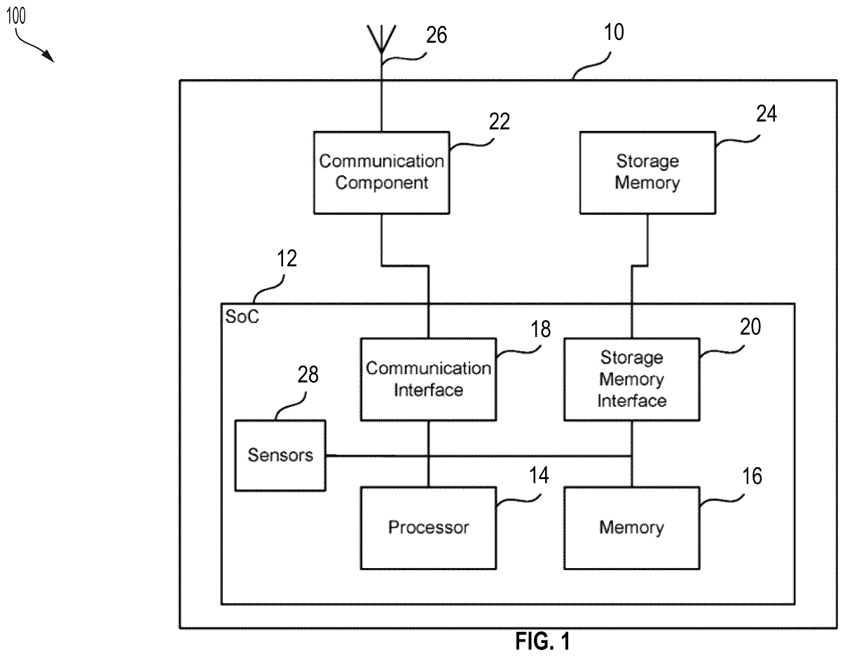

FIG. 1 illustrates a system 100 including a computing device 10 suitable for use with various embodiments. The computing device 10 may be included in a mobile computing device, such as a wireless communication device, according to one or more aspects of the disclosure. As other examples, the computing device 10 may be included in an MP3 player, a laptop computer, or a non-portable electronic device such as a desktop computer, a game player, a television (TV), a media player, or an automotive computer system. The computing device 10 may include an SoC 12 with a processor 14, a memory 16, a communication interface 18, a storage memory interface 20, and sensors 28. The computing device 10 may further include a communication component 22, such as a wired or wireless modem, a storage memory 24, and an antenna 26 for establishing a wireless communication link. The processor 14 may include any of a variety of processing devices, for example a number of processor cores.

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster. The processors 14 may control the general operations of SoC 12 and optionally the specific actions of any of the components thereof. The processors 14 may be implemented, for example, with a microprocessor or a central processing unit (CPU), or an application-specific integrated circuit (ASIC).

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. As illustrative examples of volatile memories, the one or more memories 16 may include a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24. The storage memory interface 20 may include or correspond to a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The sensors 28 may be communicatively coupled to the processor 14, the memory 16, the communication interface 18, and the storage memory 20 via a bus or other communication link. The sensors 28 may include thermal sensors and/or voltage sensors physically located within the SoC 12. The sensors 28 may measure thermal and electrical characteristics (e.g., temperature and voltage values) throughout the SoC 12 during testing and normal operating procedures as described by embodiments. Temperature values and voltage values measured by the sensors 28 may be conveyed to the processor 14 for processing, stored in the memory 16, and/or conveyed from the SoC 12 through the communication interface 18 to other components in the computing device 10.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device 10. For example, the communication interface 18 may be used to convey measured in-field characteristics to the communication component 22. The communication component 22 may relay the measured in-field characteristics to external additional computing devices for purposes of diagnosing any errors based on the in-field characteristics. Similarly, the memory 16, storage memory interface 20, and storage memory 24 may store and convey the measured in-field characteristics and other associated data as according to the various embodiments.

In SoCs, one or more components of the SoC may be put to a low power mode or sleep mode during operation to conserve power. Components in these low power modes or sleep states may be booted back up to provide a service to a user. Some components may need to be booted back up quickly to restore critical functions, such as automotive safety systems. SoCs have quick boot features to restore or wake-up these components more quickly than from a cold boot.

During the wake-up process in SoC from a deep sleep, a Suspend to RAM (STR) state, or another similar sleep state (e.g., a sleep state where the caches are powered down), the subsystem memories and/or internal caches are reinitialized. The initialization processes involves vector Tightly Coupled Memory (vTCM) and layer 2 (L2) cache clean-up because, when a Subsystem wakes up from deep sleep, it needs to ensure that the memory it uses is in a consistent state. Cleaning up the vTCM and cache memory helps to remove any stale or outdated data that might cause conflicts or errors.

The memory or cache controller typically handles the clean-up process. When the SoC wakes up from a deep sleep or STR state, the cache controller is responsible for ensuring that the caches, such as the vTCM, are properly reinitialized. This memory initialization process is one part of a quick-boot process where the SoC wakes up from a sleep state where the caches are powered down, and the memory initialization process takes up a significant portion of the quick boot process.

The memory initialization process generally involves: disabling the memory, enabling error correction control (ECC) for the memory, cleaning up the memory, and enabling the memory for use. The whole memory initialization process may take a significant portion of the overall time from quick boot start to run time initialization start. As the quick boot process is performed serially, the memory clean-up and initialization have to wait on some initial operations, and the other non-memory clean-up and initialization operations have to wait while the entire memory clean-up and initialization process finishes.

When disabling the cache, the processor needs to disable the cache by writing to the appropriate control bits to the cache memory to ensures no other process is using the cache memory. Enabling ECC for the cache includes enabling the ECC protection for a particular cache region. Cleaning up the cache ensures that the cache lines are up-to-date and ready for use. Cache lines can be cleaned up by writing 0s to them. Additionally, as part of this clean-up, ECC meta data region is also reinitialized. Enabling the cache includes enabling back the cache memory by writing to the appropriate control bits to make the cache usable again. This process helps maintain data integrity and ensures that the system operates smoothly after waking up.

In such quick boot sequences, a few issues may be present. For example, the cache clean-up and re-initialization during the wake-up process can overload the subsystem with increase in cache memory size. This can induce the following problems, increased wake-up latency, performance impact, and ECC re-initialization latencies. The increased wake-up latency refers to the time taken to clean and reinitialize the cache and this adds to the overall wake-up time of the Subsystem. This delay can be critical in systems that require fast wake-up times, such as real-time applications or devices with stringent power management requirements. The performance impact suffered by the system during the cache clean-up causes the CPU and other subsystems to wait until the cache is ready, which can temporarily degrade performance. This is especially noticeable in systems that rely heavily on cache for quick data access. The ECC re-initialization latencies issues exist in large size memory regions where ECC protection is enabled, such as in automotive SoCs, which require re-initialization during Quick-Boot/Warm boots. This can delay the boot-up cycle.

In Automotive SoCs, where the subsystems like Audio (LPASS) and Modem have strict requirements of fast wake-up, cache clean-ups can contribute significantly to adding delays to the wake-up. This can lead to major security and safety issues.

In the aspects herein, a novel technique to parallelize the memory clean-up and initialization operations with the other quick book sequence operations is described. For example, multiple hardware threads or processor cores can be used to perform memory clean-up and initialization operations in parallel with other quick book sequence operations. Performing different operations with different threads or processors concurrently enables a reduction in the overall time to initialize the DSP or subsystem and enables earlier completion of the quick book process by offloading the memory initializations and clean-up tasks and optionally starting or initializing the subsystem before memory clean-up and initialization is completed. For example, the memory initializations and clean-up tasks may be performed by a different thread or processor as to not delay the other quick boot operations which enables an earlier initialization (e.g., RCINIT) of the DSP or subsystem. Many different divisions of task and parallelization can be used to reduce the processing time, but a few examples are described and illustrated below.

In some aspects, the proposed parallelization techniques include a Direct Memory Access (DMA) engine trigger event (e.g., signal or interrupt) and Direct Memory (DM) polling for clean-up completion, and such actions may enable parallelization of the memory clean-up and initialization operations of the quick boot process. To illustrate, the SoC (e.g., a subsystem or OS thereof) sends an interrupt to a DMA engine to initiate memory clean-up-up and initialization operations using one thread and may use another thread to perform other quick boot sequence operations and poll the DMA engine for clean-up completion, which enables parallelization of memory clean-up and initialization operations with other quick boot sequence operations. Thus, the memory clean-up tasks and initialization and can be performed by the DMA engine in parallel to the other actions of the quick boot sequence and the wake-up of the DPS or other subsystems happens earlier.

In some examples, the SoC, such as the OS thereof, first restores hardware components (e.g., provides power to such components, like the memories) and initializes timers and interrupts. The OS saves the start address and range for the memory to be cleaned up and interrupts, such as by writing to a trigger register or signaling an event, the DMA Engine to start the clean-up and initialization operations and essentially engage in parallelization. To illustrate, after the subsystem (e.g., LPASS) has restored the power for the corresponding caches (e.g., L2, vTCM, and/or ECC), the subsystem saves the descriptors (e.g., start address and range of vTCM memory) and starts the DMA engine with DMStart command, which includes the start addresses and size/range of memory to be cleaned and initialized. The subsystem can then engage in DMPoll operations for clean-up completion and continue with the other wake-up tasks and run time initialization processes in parallel with the DMA operations, which is while the DMA is cleaning up and/or initializing the vTCM memory. To keep tabs on the clean-up completion status, the quick boot notification framework polls the DMA engine with a DMPoll message for clean-up completion status. Once all the run time initialization processes are completed and the polling indicates a success (e.g., positive response to DMPoll message), the quick boot notification framework marks the system as ready.

In the aspects described herein, a deep sleep mode or deep sleep state corresponds to a sleep state where memory, such as double data rate (DDR) memory, of the SoC is in a self-refresh state and all other SoC power rails are off (e.g., in a powered down state/disconnected from power supply). In some such implementations, a logic rail (e.g., LX or CX rails) may be off, a crystal oscillator (XO) rail (e.g., XO rail) may be off, and a memory rail (e.g., MX rail) may be off. In some other implementations, the memory rail may be at retention level for DDR self-refresh. In some aspects, the deep sleep state corresponds to a sleep state that is deeper than a rock-bottom sleep (RBS) state and has a quick boot wake-up ability and DDR memory retention. The deep sleep state may extend to all component or subsystems of the SoC, such as always-on subsystems (AOSS). For example, in a particular aspect, the quick boot wake-up of the deep sleep state from PMIC boot includes early Audio operations within 700 msec, display within 700 msec, and camera within 1200 msec from PMIC boot. The RBS may be a low power mode for the SoC such that it is non-functional, but that the state of the SoC is retained for “immediate” return to operation once clocks and voltages are restored.

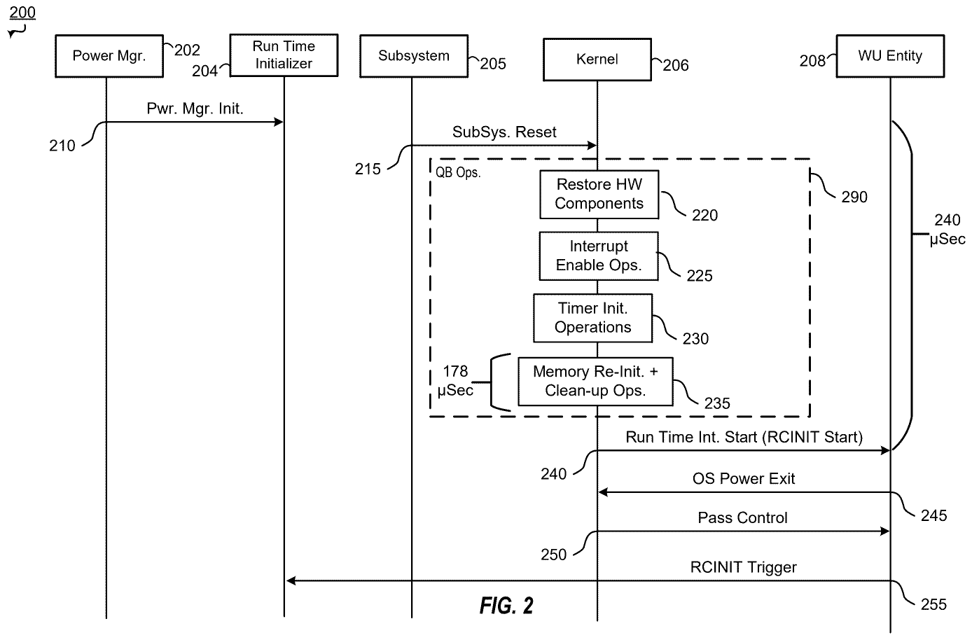

Referring to FIG. 2, FIG. 2 is an example of quick boot operations for an SoC, such as the SoC 12 of FIG. 1. In FIG. 2, a flow diagram of quick boot operations with memory clean-up and initiation is illustrated.

In the example of FIG. 2, the circuit architecture of the SoC includes a power manager 202, a run time initializer 204 (e.g., a RCINIT), a subsystem 205, a kernel 206, and a wake-up entity 208 (WU Entity), with the subsystem 205 being the subsystem that is being quick booted from deep sleep.

The power manager 202 may include or correspond to circuitry or logic configured to control power delivery for at least a portion of the SoC. The power manager 202 may be configured to provide power to clients and components of the SoC and to implement power states of the SoC. For example, the power manager 202 may be configured to control operation of one or more power rails of the SoC, such as a logic power rail, a memory power rail, a crystal oscillator power rail, etc., and control of the power rails may include switching between configurations of the power rails of the SoC and/or of circuitry of the power manager 202, which may be associated with particular power modes, such as on, low power, sleep, RBS, deep sleep, etc.

The power manager 202 may include or correspond to a power management integrated controller (PMIC) in some aspects. The power manager 202, or PMIC thereof, may be configured to control or initiate quick boot operations for components of the SoC, such as subsystem 205. Additionally, or alternatively, the power manager 202 may be configured to control power management operations and provide power to one or more components of the SoC. For example, the power manager 202 may be configured to restore power to the subsystem 205 and the associated memory for the subsystem 205. The power manager 202 may include a wake-up or quick boot programable boot sequence (PBS), and the quick boot PBS may include or correspond to a logical sequence or series of steps for activating power rails and transitioning components of the SoC from a sleep state (e.g., the deep sleep state) to an active state.

The run time initializer 204 may include correspond to circuitry or logic configured to control run time initialization operations for at least a portion of the SoC of FIG. 2. For example, run time initializer 204 may include or correspond to a finite state machine (FSM), a microcontroller with firmware, a programmable FSM, or a logical sequence or series of steps for performing run time initialization operations for subsystems, such as subsystem 205, resuming or waking from a sleep state (e.g., deep sleep).

The kernel 206 may include or correspond to an operating system or operating system instructions executed by a processor, such as a CPU. The kernel 206 corresponds to a single processor or event routine that is completed serially or sequentially to quick boot the subsystem 205.

The kernel 206, such as the associate operating system thereof, may include or function as a direct memory access engine or a memory manager or controller for a memory associated with the CPU and/or subsystem 205. For example, the direct memory access engine may be configured to control and coordinate memory operations and access, such as read and write operations, interrupt operation, priority access, etc. As another example, the direct memory access engine may be configured to control and coordinate transition of a memory between power states (sleep, deep sleep, standby, low power, normal, etc.) and/or modes (e.g., enabled, disabled, ECC, etc.). The direct memory access engine may be configured to control performance and power states of the memory (not shown) of the SoC. Additionally, or alternatively, the direct memory access engine may be configured perform clean-up operations, initialization operations, or both.

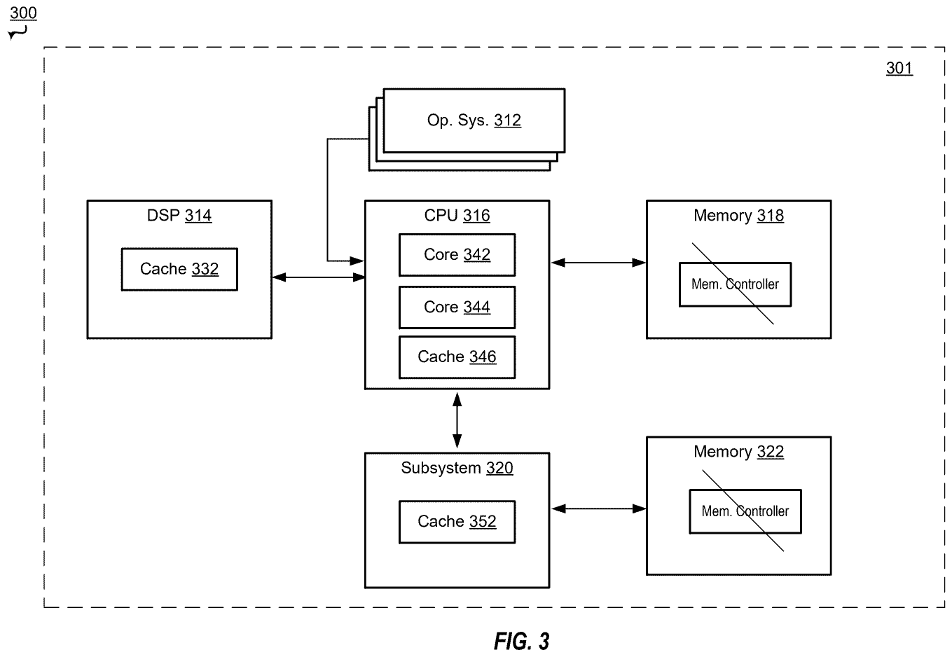

The memory may include or correspond to a cache memory or a vTCM memory that does not include its own dedicated controller. The memory may include a plurality of memory blocks or cache lines. The memory, the direct memory access engine, or both, may also include a control register or control register space configured to store information regarding a mode or state of the memory. Additional examples of the memory are further described with reference to FIG. 3.

The wake-up entity 208 (e.g., wake-up logic) configured to control and perform wake-up operations. For example, the wake-up entity 208 may include or corresponds to a controller or command set and is configured to prepare components resuming operations after entering a sleep state and/or recreating a retained save state. For example, the wake-up operations may be configured to control or coordinate run time initialization operations.

The wake-up entity 208 may include or correspond to a finite state machine (FSM), a microcontroller with firmware, a programmable FSM, or a logical sequence or series of steps for preparing clients and/or components for resuming or waking from a sleep state (e.g., deep sleep).

The wake-up entity 208 may be implemented by dedicated hardware (e.g., circuitry), a microcontroller, software running on a processor, or a combination thereof. The wake-up entity 208 may be configured to be independent from and not have a dependency on memory to function. To illustrate, if the wake-up entity 208 is or includes a processor, then the wake-up entity 208 includes its own dedicated storage separate from the DDR memory, such as on-die RAM or NOR flash memory.

Although the components of the SoC architecture of FIG. 2 are illustrated as separate components, in some implementations, two or more of the components are unitary or part of the same component.

During operation of the SoC of FIG. 2, at 210, the power manager 202 transmits an initialization signal to a run time controller. For example, the power manager 202 transmits a power management initialization transmission to the run time initializer 204. The initialization signal (e.g., power management initialization transmission) may be configured to trigger start of a wake-up process from a sleep state. For example, the initialization signal (e.g., power management initialization transmission) may be configured to trigger a reset signal for a subsystem, such as subsystem 205, which may be referred to as triggering a boot operation. The boot operation may include quick boot operation or a warm boot operation, or any other resume operation from a sleep state, such as deep sleep state. In the example of FIG. 2, the initialization signal triggers a quick boot sequence, and an example quick boot sequence is illustrated by the operations performed at 220-235 in box 290.

In the example of FIG. 2, the quick boot operation starts with an initialization signal from the power manager 202 to the run time initializer 204, which triggers a subsystem reset and a quick boot sequence steps by the operating system kernel, kernel 206, shown in box 290 and performed serially.

At 215, the subsystem 205 sends a reset signal to the kernel 206 (e.g., an operating system (OS)). For example, the subsystem 205 sends a subsystem reset signal to a processor, such as the CPU of a SoC, based on and/or responsive to the initialization signal being sent and/or received at the run time initializer 204 at 210. Although not illustrated in FIG. 2 for clarity, the power manager 202 and/or the run time initializer 204 may send a message or signal to the subsystem 205 to trigger the reset signal. In some implementations, the reset signal includes or corresponds to a quick boot, warm boot, or resume signal.

Responsive to receiving the reset signal from the subsystem 205, the kernel 206 serially performers a quick boot sequence (or other resume sequence) as illustrated in box 290. The kernel 206 is implemented by a single thread on a single processor and it serially performs wake-up operations, notification operations, and memory clean-up and initialization operations for an associated memory, not shown in FIG. 2. The memory includes or correspond to a memory without a dedicated controller, such as an internal cache memory to the processor or a tightly coupled memory for the processor, such as a vTCM.

As illustrated in the example of FIG. 2, at 220, the kernel 206 performs operations to restore hardware components. For example, the kernel 206 first performs actions to bring various hardware components that are associated with the subsystem 205 from a resume or sleep state. To illustrate, the kernel 206 may restore one or more interrupt controllers, such as a second-level vector interrupt controller (L2VIC), power rails, such logic, memory, subsystem and/or oscillator power rails, system timers, such as subsystem timers or related subsystem timers, or any combination thereof.

At 225, the kernel 206 performs interrupt enable operations. For example, the kernel 206 performs one or more interrupt operations related to the subsystem 205. The one or more interrupt operations may include hardware interrupts, software interrupts, or a combination thereof. To illustrate, the kernel 206 sends one or more interrupt request (IRQs) to components related to the subsystem 205 and resuming the subsystem 205. These interrupts may include one or more interrupts associated with entering the sleep state. For example, the interrupts that were enabled for entering the sleep state are disabled. The kernel 206 may save descriptors containing a start address and range of the memory to be cleaned up, and the descriptors may be used for controlling memory clean-up and initialization operations.

At 230, the kernel 206 performs timer initialization operations. For example, the kernel 206 performs initializes one or more timers that are associated with the subsystem 205, such as with the operation thereof, and/or the boot sequence for resuming the subsystem 205. To illustrate, the kernel 206 may set and start one or more timers related to the subsystem 205 and/or may set and start one or more timers related the boot sequence for resuming the subsystem 205. The kernel 206 may use a quick boot timer (e.g., Qtimer) framework for setting the timers and based on quick boot sequence timer configuration information.

At 235, the kernel 206 performs memory clean-up and initialization operations. For example, the kernel 206 performs operations on the memory to maintain data integrity and prepare the memory for use by the subsystem. To illustrate, the kernel 206 disables the memory, cleans-up the memory, and enables the memory. In some aspects, where the memory is an ECC mode or operating in an ECC mode, the kernel 206 may additionally enable ECC for the memory. Disabling the memory may include writing control bits configured to disable the memory, such as to the cache lines or register control space. Enabling ECC may include setting an ECC flag or control bits. Cleaning-up and/or initializing the memory may include preparing the memory, and blocks/lines thereof, for use. This may include writing a bit value, e.g., a logic low or 0, to each of them. When ECC is involved the clean-up and initializing may include writing bit values to the ECC meta data region. To enable the memory, the kernel 206 may write enabling control bits to the memory, cache lines or control register space, to enable use of the memory again.

At 240, the kernel 206 performs run time initialization start operations. For example, the kernel 206 sends a run time initialization start indication to the wake-up entity 208 to start run time initialization operations responsive to completion of the quick boot sequence by the kernel 206, i.e., responsive to the completion of the memory clean-up and initialization operations at 235.

At 245, the wake-up entity 208 (WU Entity) sends an operating system power exit trigger to the kernel 206 to enable termination of the operating system. For example, the wake-up entity 208 (WU Entity) sends an operating system power exit message to the kernel 206 to enable termination of the quick boot sequence operating system based on and/or responsive to receiving the run time initialization start indication at 235 and/or determining a run time initialization start trigger.

At 250, the kernel 206 passes quick boot operational control to the wake-up entity 208 (WU Entity). For example, the kernel 206 sends a control transfer indication or message to the wake-up entity 208 to provide or pass control to the wake-up entity 208 based on and/or responsive to receiving the operating system power exit message or indication at 240 and/or determining a quick boot operational control trigger.

At 255, the wake-up entity 208 (WU Entity) sends a run time initialization operation trigger indication to the run time initializer 204 to trigger run time initialization operations for run time initializer groups. For example, the wake-up entity 208 (WU Entity) sends run time initialization operation trigger message to the run time initializer 204 to trigger run time initialization operations for multiple run time initializer groups of or associated with the subsystem 205 based on and/or responsive to being passed control at 250. The run time initialization operations for the multiple run time initializer groups (e.g., the operations performed by the groups) may be performed in parallel.

After 255, the run time initializer 204 performs run time initialization operations for run time initializer groups (e.g., RCINIT groups) and receives notifications of completion of the run time initialization operations. The quick boot process ends upon competition of the run time initialization operations for each of the run time initializer groups, and upon completion of the quick boot process, the memory is usable. For example, the memory (e.g., cache or vTCM) is usable by the subsystem 205.

In some aspects, the performance of the memory clean-up and initialization operations at 235 may take up a large portion of the time of the quick boot process, and it may take up a majority of the time of the quick boot sequence in box 290. As illustrated in the example of FIG. 2, the performance of the memory clean-up and initialization operations at 235 take 178 microseconds (μs) for some types of systems, such as for cleaning up an 8 MB cache. In the example of FIG. 2, the total time from quick boot time to run time initialization start for the subsystem is 240 μs, that is from initialization by the power manager 202 at 210 to the transmission of the run time initialization start indication at 240. Thus, the start of the run time initialization process, i.e., the time to sending the run time initialization start indication at 240 is delayed or slowed due to memory cleaning operations, and this delay is only expected to grow as memories get larger in the future.

Although one subsystem is shown in the example of FIG. 2, the SoC may have multiple subsystems in other aspects, and one or more of such subsystems may be quick booted. The subsystems themselves may include one or more discrete components of the SoC and may have a monolithic configuration or a distributed configuration. In monolithic configurations, the subsystem may include or correspond to a single discrete component on the SoC, such as a single IC, boards, or chip, etc. In distributed configurations, the subsystem may include or correspond to multiple discrete components on the SoC, such as multiple ICs, boards, chiplets, etc.

Although acknowledgements are not shown, each message or indication may have an associated acknowledgement (ACK). Additionally, or alternatively, although most message or indications are described as push or triggering indications, in some implementations, such messages or indication may be pulled or prompted by a request or trigger message.

Referring to FIG. 3, FIG. 3 is an example of an SoC architecture compatible with enhanced memory restoration operations according to some aspects. FIG. 3 is a block diagram 300 illustrating an example of a SoC 301 for a circuit or system, such as the SoC of FIG. 1 and/or any components thereof.

In FIG. 3, the SoC 301 includes a plurality of clients 312, a DSP 314, a CPU 316, a memory 318 (first memory), a subsystem 320, and a memory 322 (second memory). The CPU 316 is a multiple core processor and includes at least a first core 342 and a second core 344. Each core may be configured to execute or host one or more processor threads, also referred to a hardware thread. The memory 318 may include or correspond to a general or shared memory of the SoC 301 or an external memory or cache for the CPU 316, such as a TCM or vTCM. The memory 322 may include or correspond to a dedicated external memory for the subsystem 320, such as a TCM or vTCM. In some aspects, one or more of the memories, such as memory 318, memory 322, or both, may not include a dedicated memory controller on-chip or off-chip. Rather, the CPU 316 may include a direct memory access engine or DMA engine and may function as the controller for the memory. Additionally, or alternatively, the components of the SoC 301 may include or more memories or internal caches as illustrated in FIG. 3. As illustrative, non-limiting examples, the DSP 314 include cache 332, the CPU 316 includes cache 346, and the subsystem 320 includes cache 352. As illustrative, non-limiting examples of memory types for the memories that the SoC 301 may include, and for which the SoC 301 may transition to a sleep state and quick boot from the sleep state, the memory type may include or correspond to a TCM memory (e.g., L1 TCM, L2 TCM, etc.), a vTCM, a vectored cache/Tightly coupled memory, a MMU TLBs, an instruction cache, a data cache, a unified caches (e.g., L2 cache), L2 cache tag information, etc.

During operation of the SoC 301, one or more components of the SoC 301 may be transitioned to a sleep state to conserver power, such as the DSP 314, the subsystem 320, or both. To quickly return the component or components to power and functionality, the SoC 301 may quick boot the components to more quickly bring them online and into use. However, booting up components from sleep incurs a processing delay and especially when the component has a corresponding memory that is to be cleaned to maintain data integrity and reduce or prevent errors.

Thus, a quick boot of one of the components of the SoC 301 may involve cleaning a one or more memories of the SoC 301. For example, a quick boot of the DSP 314 may involve a cleaning of one or more of the caches 332 of the DSP 314, the cache 346 of the CPU 316, or the memory 318. As another example, a quick boot of the subsystem 320 may involve a cleaning of one or more of the caches 346 of the CPU 316, the cache 352 of the subsystem 320, the memory 318, or the memory 322. That is, a quick boot of a component may include cleaning one or more memories that may be used by the component directly, such as an internal cache or external memory associated with the components, and/or one or more memories that may be used by the CPU 316 for the components, such as internal CPU cache memories (e.g., cache 346) and external memories for the CPU 316 (e.g., memory 318).

The enhanced quick boot operations described herein may involve quick booting one or more components of the SoC 301, such as the DSP 314 and/or the subsystem 320, and may involve cleaning one or more of the caches or memories shown in FIG. 3. As compared to prior quick boot operations with serial performance of quick boot operations and/or events, the enhanced quick boot operations described herein leverage parallelization to perform quick boot operations in parallel. In some aspects, wake-up task operations and/or notification operations may be performed in parallel with memory clean-up and/or initialization operations to reduce boot times and improve data integrity.

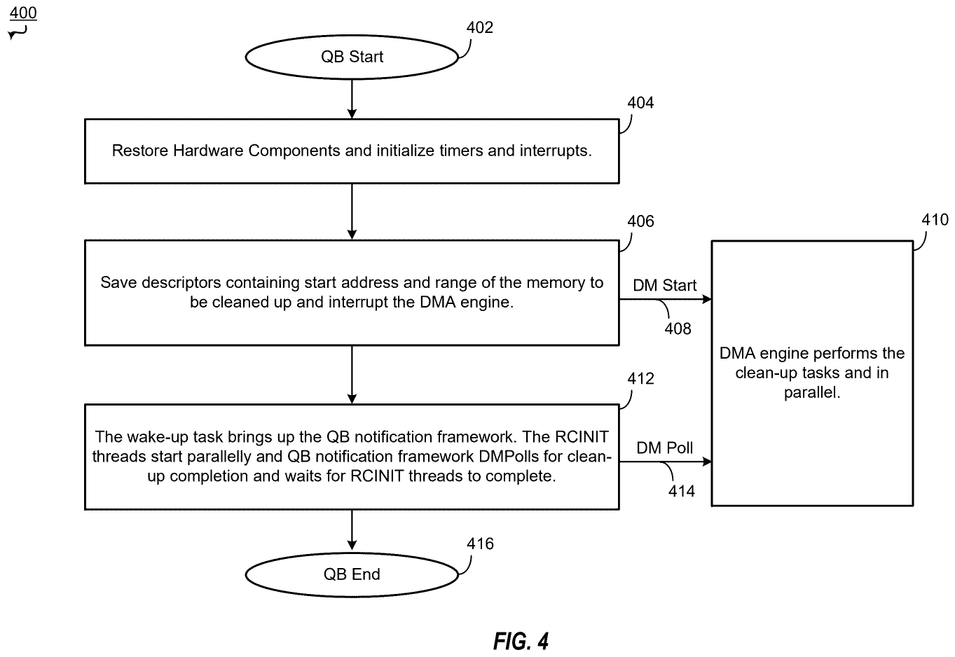

In FIG. 3, the wake-up architecture of the SoC 301 may be located on a single die, tile, or chiplet of the circuit or system. For example, a chiplet or die of the system or circuit includes wake-up logic to activate or transition the components or subsystems on the chiplet or die from a deep sleep mode or state into an active mode or state. For example, the CPU 316 (e.g., the central or main general-purpose processor) may perform (e.g., instruct or carry out) the quick boot actions described with reference to FIG. 2. To illustrate, the CPU 316 may function as one or more of the components described with reference to FIG. 2 and/or one or more of the components described further with reference to FIGS. 4-6.

The enhanced quick boot operations of the SoC 301 of FIG. 3 are described further with reference to FIGS. 4-6. For example, the cores 342 and 344 of the CPU 316 may perform or coordinate the quick boot and memory clean-up and initialization operations in parallel for a component of the SoC 301, such as DSP 314 or subsystem 320.

Referring to FIG. 4, FIG. 4 is a flow chart illustrating a method 400 for enhanced memory restoration operations for SoCs according to some embodiments of the disclosure. In some implementations, the method may be performed by the SoC, and any components thereof, of FIGS. 2-8. For example, the components of the SoCs of FIGS. 2-8 may perform memory clean-up operations.

As compared to the serial performance of quick boot and memory clean-up operations using a single thread in the example of FIG. 2, in the example of FIG. 4 the quick boot and memory clean-up operations are performed in parallel using more than one thread. For example, a first thread may perform wake-up task operations and/or quick boot notification operations, and a second thread may perform memory clean-up and initialization operations. Rather, each DDR memory manager communicates with a corresponding deep sleep entity of their respective chiplet to relay, vote, or indicate a status of their respective DDR memory to the corresponding deep sleep entity.

During operation, at 402 a quick boot operation is started. For example, a quick boot process may be initialized by the operations described with reference to 210 and 215 of FIG. 2. After the start of the quick boot operation, the quick boot operation may commence and the operations of the quick boot sequence may be performed, such as those illustrated in box 290 of FIG. 2. However, as compared to the example of FIG. 2 where the operations of the quick boot sequence are performed serially/sequentially, in the example of FIG. 4, one or more operations of the quick boot sequence are performed concurrently or in parallel by two or more hardware threads.

At 404, the first thread restores hardware components and initializes timers and interrupts. For example, the first thread may perform multiple actions to restore power and/or operation to components of the subsystem or associated with the subsystem from the sleep modem, and the first thread may set and start timers associated with the subsystem, with the related components, and/or with the quick boot sequence itself. These actions may involve programming timers in the kernel or kept by the first thread and/or sending messages to components of the SoC to set and/or start timers. The first thread may utilize one or more interrupts to restore the hardware components and/or to initialize the timers.

At 406, the first thread saves descriptors containing start address and range of the memory to be cleaned up and interrupts the DMA engine. For example, the first thread may determine and store the memory addresses to be cleaned and initialized. To illustrate, the first thread may determine to clean and initialize one or more portions of at least one memory, the entire memory, or multiple memories. The first thread may determine the addresses (e.g., memory blocks, cache lines, etc.) to be cleaned based on the memory assigned or associated to the subsystem that is being quick booted, and/or based on the memory in use or suspended during the prior sleep operation for the subsystem. To illustrate, the first thread may transmit messages to a storage device or its internal cache which was not in a sleep mode to recall the memory addresses in use for the memory being cleaned and initialized as part of the quick boot process.

At 408, the first thread sends a DM start signal to the second thread to engage in memory clean-up and initialization operations. For example, the second thread may include or correspond to DMA engine, that is performing the functions of a DMA engine for the memory associated with the subsystem being booted, and the first thread may send a DM start signal to the second thread, or DMA engine thereof, to perform memory clean-up operations. The DM start signal may include memory cleaning information, memory initialization information, or a combination thereof. The memory cleaning information and memory initialization information may include data indicating a start address or addresses of the memory to be cleaned or initialized respectively and an end address or addresses of the memory to be cleaned or initialized respectively. For example, the DM start may indicate a start address and end address specifically, or it may indicate a start address and an amount or range of addresses to be cleaned, thereby indirectly indicating the end address and the specific portion or portions of the memory to be cleaned (and/or initialized).

In some aspects, the DM start signal includes or corresponds to an interrupt signal or request. The DM start signal or interrupt request may be acknowledged by the second thread with a response message, not shown in FIG. 4. In some other aspects, the DM start signal is preceded by an interrupt signal or request and is sent in response to an acknowledgment message from the second thread.

At 410, the second thread performs the memory clean-up and initialization operations. For example, the second thread performs the memory clean-up and initialization operations in parallel with the quick boot sequence operations of the first thread. To illustrate, in some aspects the memory clean-up operations, the memory initialization operations, or both, are performed at overlapping times or simultaneously with one or more of the wake-up task operations, one or more of the quick boot notification operations, or a combination thereof. As one illustrative, non-limiting example, the memory clean-up operations may be performed by the second thread while the first thread is performing wake-up tasks. As another illustrative, non-limiting example, the memory initialization operations may be performed by the second thread while the first thread is performing notification tasks. Additionally, or alternatively, the memory clean-up and/or initialization operations may be performed by the second thread while the first thread is performing run time initialization operations. Although a few illustrative examples, are provided, any combination of the above tasks may be performed in parallel and simultaneously by the two threads.

The memory clean-up and initialization operations may depend on the memory type (e.g., volatile or non-volatile, RAM, ROM, etc.) and the type of memory cell (MOS-based, gate-based, latch-based, magnetoresistive, etc.). The memory clean-up and initialization operations may generally include disabling the memory, cleaning up the memory, and enabling the memory. If the memory has ECC capability, such as for some cache memories, the memory clean-up and initialization operations may also include enabling ECC for the cache after disabling the cache and prior to cleaning-up the cache. Enabling ECC for the cache may include setting an ECC control bit and/or engaging in ECC operations, such as checking for errors, logging errors, clearing an error history, performing CRC, etc.

As an illustrative, non-limiting example, the memory clean-up operations may include writing control bits to the memory to disable use of the memory. This ensures no other processes can use the memory during this time. Writing control bits to the memory may include writing a first bit value (e.g., control bit) to a memory control register or writing a first bit value to one or more cache lines of a plurality of cache lines of the memory, such as to each memory block. In some aspects, the first bit or control bit may be written to each cache line of the plurality of cache lines. As an illustrative, non-limiting example, the memory initialization operations may include writing a second bit value to each cache line of the plurality of cache lines. The second bit value may be the same as a first bit value or different. In some aspects, the second bit value may include or correspond to a reset value, such as all zeros or all ones.

At 412, the first thread performs the wake-up task operations and the quick boot notification operations. For example, the first thread performs one or more wake-up task operations, such as sends messages or executes commands to restore hardware components and/or hardware configurations. To illustrate, the first thread restores or messages another component to cause restoration of interrupt controller initializations, memory management unit initializations and configurations, power rails, etc. The wake-up task operations may additionally or alternatively include setting up a scheduler for multi-threading or multi-core operation. As another example, the first thread performs one or more quick boot notification operations, such as sending messages to notify the subsystem and components that interact with or depend on the subsystem that the subsystem is undergoing a quick boot. To illustrate, the first thread may notify the other subsystems (or components within the same subsystem) via interrupts, command-line memory reporting tools (such as SMEM), message queue protocols, signals, trigger events, etc. The wake-up task operations and the quick boot notification operations prepare the SoC and subsystem for run time initialization operations. The wake-up task operations and the quick boot notification operations may notify the subsystem and components that the associate memory or memories are being cleaned-up and initialized.

At 414, the first thread sends a DM poll signal to the second thread to poll or inquire about the completion of the memory initialization operation. For example, the first thread sends a DM poll message or request to the second thread, or DMA engine thereof, to inquire about a completion status of the memory clean-up operations and/or memory initialization operations. In some aspects, the DM poll message may cause an immediate response of the status of the memory clean-up operations and/or memory initialization operations. For example, the second thread may respond with a positive indication or a negative indication based on a status of the memory clean-up operations and/or memory initialization operations.

In some other aspects, the DM poll message may cause the second thread to respond only if the memory clean-up operations and/or memory initialization operations are completed or, when the operations are not complete, to respond at some time in the future when the memory clean-up operations and/or memory initialization operations are completed.

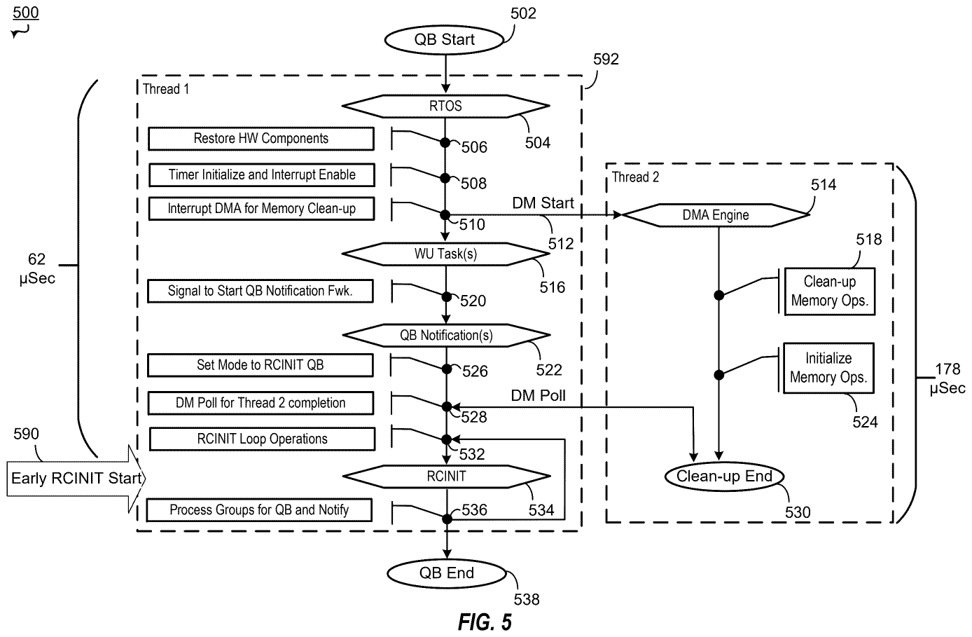

Before or after the DM poll message is sent, the first thread may continue performing quick boot operations, such as run time initialization operations. The run time initialization operations may be performed responsive to the sending of the DM poll message, completion of the quick boot notification framework or both. The run time initialization operations may include or correspond to initialization of one or more run time initialization threads for one or more run time initialization groups, such as one or more of the operations described with reference to 240-255 of FIG. 2. As another example, the run time initialization operations may include or correspond to run time initialization operations (e.g., RCINIT operations) as described further with reference to 532-536 of FIG. 5.

At 416, the quick boot operation is ended. For example, the quick boot process may be completed by the SoC, or processor thereof, as described with reference to FIG. 2. For example, the quick boot operation may end after the operations of the quick boot sequence, such as those illustrated in box 290 of FIG. 2, or after the completion of the run time initialization operations, such as after completion of initialization of run time initialization groups after the run time initialization trigger sent at 255 of FIG. 2.

Although FIG. 4 is directed to an example of a quick boot, in other operations a warm boot or another boot from a sleep state with powered off caches or suspend to RAM may utilize parallelization techniques similar to those described with respect to the quick boot operations of FIG. 4. For example, the warm or other boot operation may utilize parallelization of boot-up tasks with memory clean-up tasks.

Although FIG. 4 is directed to an example of a parallelized boot operation utilizing two threads, in other operations more than two threads can be used. For example, three threads may be utilized to perform the quick boot sequence operations. To illustrate, a first thread may perform wake-up task operations, a second thread may perform quick boot notification operations, and a third thread may be used to perform memory clean-up and initialization operations. As another example, four or more threads may be utilized to perform the quick boot sequence operations. To illustrate, one thread may perform wake-up task operations, another thread may perform quick boot notification operations, and multiple threads may be used to perform memory clean-up and initialization operations. The multiple threads may be used to perform memory clean-up and initialization operations on a single memory or multiple memories.

Although FIG. 4 is directed to an example of a parallelized boot operation where a first thread performs wake-up task operations and quick boot notification operations and a second thread performs memory clean-up and memory initialization operations, in other operations the threads may perform different task or even share certain tasks. For example, the wake-up task operations and memory clean-up operations may be performed by one thread and the quick boot notification operations and memory initialization operations may be performed by the other thread.

Referring to FIG. 5, FIG. 5 is a flow chart illustrating a method 500 for enhanced memory restoration operations for SoCs according to some embodiments of the disclosure. In some implementations, the method may be performed by the SoC, and any components thereof, of FIGS. 2-8. For example, the components of the SoCs of FIGS. 2-8 may perform memory clean-up operations. To illustrate, a first hardware (processor) thread and a second hardware (processor) thread of a processor may perform the operations illustrated in FIG. 5. The threads, thread 1 and thread 2, as illustrated in FIG. 5 may belong to a same, single core of the processor or to different cores of the processor.

During operation, at 502 a quick boot operation is started. For example, a quick boot process may be initialized by the operations described with reference to 402 of FIG. 4. After the start of the quick boot operation, the quick boot operation may commence and the operations of the quick boot sequence may be performed, such as those illustrated in box 290 of FIG. 2 or in the method 400 of FIG. 4.

At 504, the first thread 592 (thread 1) performs the operations of a real-time operating system (RTOS). For example, the first thread 592 (thread 1) may load a RTOS or perform the actions of or for a RTOS. The RTOS may include or correspond to an operating system (OS) for real-time computing applications that processes data and events that have defined time constraints. In the example of FIG. 5, the RTOS may include or correspond to an RTOS for quick boot operation and/or an RTOS for the subsystem to be quick booted. The operations performed by the RTOS may require verification of completion within given time and resource constraints. The RTOS may be event-driven or clock driven, and may monitor the relevant priority of competing tasks, and make changes to the task priority as needed. The RTOS may switch between tasks based on their priorities, based on timers, and may utilize interrupts to do so.

At 506, the first thread 592 (thread 1) performs one or more operations to restore hardware components. For example, one or more hardware components of the SoC may have been put to sleep or turned off during the prior sleep state for the subsystem which is now being booted by the quick boot operation. The first thread 592 (thread 1) may performs notification operations, such as by sending messages, to activate, restore, or provide power to the one or more hardware components. As illustrative, non-limiting examples, the hardware components may include one or more hardware components used by the subsystem being booted and/or used by the associated memory being cleaned, such as one or more vector processors, one or more scalar processors, one or more DMA engines, etc.

At 508, the first thread 592 (thread 1) performs one or more timer initialization operations and one or more interrupt enable operations. For example, the first thread 592 (thread 1) performs one or more operations to initialize a subsystem timer for or related to the subsystem being quick booted or to send a scheduling interrupt, such as an Intra-process interrupt (IPI) or a Shared peripheral interface interrupt (SPI).

At 510, the first thread 592 (thread 1) performs DMA interrupt operations. For example, the first thread 592 (thread 1) may send a DMA start message to the second thread 594 (thread 2) at 512, which includes or is acting as a DMA engine for the memory. As another example, the DMA start message may configure or cause the second thread 594 (thread 2) to load a DMA engine, function as a DMA engine, or otherwise performs the operations of the DMA engine.

At 514, the second thread 594 (thread 2) performs DMA engine operations. For example, the second thread 594 (thread 2) loads or executes a DMA engine and performs the operations of the DMA engine. The second thread 594 (thread 2) may receive a DM start signal and perform memory clean-up and initialization operations on a memory of or associated with the processor and/or subsystem being quick booted responsive to the DM start signal. In some aspects, the DM start signal may act as an interrupt signal and may cause the second thread 594 (thread 2) to disable the memory for clean-up and initialization operations. Additionally, or alternatively, the DM start signal may be configured to cause the second thread 594 (thread 2) to act as the DMA engine, such as to load DMA engine logic or a DMA engine routine.

At 516, the first thread 592 (thread 1) performs wake-up task operations. For example, the first thread 592 (thread 1) sends messages or executes commands to restore hardware and/or hardware configurations. To illustrate, the first thread 592 (thread 1) restores or messages another component to cause restoration of interrupt controller initializations, memory management unit initializations and configurations, power rails, etc. The wake-up task operations may additionally or alternatively include setting up a scheduler for multi-threading or multi-core operation.

At 518, the second thread 594 (thread 2) performs memory clean-up operations. For example, the second thread 594 (thread 2) performs one or more of the memory clean-up operations, such as memory clean-up operations described with reference to 410 of FIG. 4, on a memory of or associated with the subsystem. The memory may be an internal memory of the processor that includes the threads 592, 594 or a memory controlled by the processor (e.g., the memory no separate memory controller) and the memory is used by the subsystem. To illustrate, the second thread 594 (thread 2) may disable the memory, such as the blocks, lines, or cells thereof, for use by other processes to enable or prepare for memory initialization operations. As an illustrative example, the second thread 594 (thread 2) may issue an interrupt command to disable memory use or write control bits to a register or control space or to cache lines to disable use of the memory. Additionally, or alternatively, the second thread 594 (thread 2) may perform ECC operations or enable ECC operations for the memory.

At 520, the first thread 592 (thread 1) signals to start a quick boot notification framework. For example, the first thread 592 (thread 1) may perform quick boot notification operations, at 522, responsive to the signal to start the quick boot notification framework. During the quick boot notification operations, the first thread 592 (thread 1) may send one or more notification messages indicating a quick boot operation for the subsystem. To illustrate, the first thread 592 (thread 1) may transmit the notification messages to the other subsystems (or components within the same subsystem) via interrupts, command-line memory reporting tools (such as SMEM), message queue protocols, signals, trigger events, etc. The one or more notification messages may be configured to cause the various recipient components to perform one or more quick boot related actions to prepare for and/or facilitate the quick boot.

At 524, the second thread 594 (thread 2) performs memory initialization operations. For example, the second thread 594 (thread 2) performs one or more of the memory initialization operations on the memory, such as the memory initialization operations described with reference to 410 of FIG. 4. To illustrate, the second thread 594 (thread 2) may prepare the memory, such as the blocks, lines, or cells thereof, for future use. As an illustrative example, the second thread 594 (thread 2) may issue a reset value command and write a reset value to each cache line (or cause a reset value to be written to each cache line). Additionally, or alternatively, the second thread 594 (thread 2) may enable (e.g., re-enable) the memory for use by other devices or processes, such as the subsystem being quick booted.

At 526, the first thread 592 (thread 1) sets the mode to run time initialization for quick boot operations. For example, the first thread 592 (thread 1) enters a run time initialization (e.g., RCINIT) mode upon completion of the quick boot notification framework operations, and optionally based on completion of the wake-up task operations, as illustrated in the example of FIG. 5

At 528, the first thread 592 (thread 1) performs a polling operation on the second thread 594 (thread 2) for a status of the DMA engine and/or memory initialization operations. For example, the first thread 592 (thread 1) may send a DM poll message to the second thread 594 (thread 2) to determine if the memory has been enabled at or after the completion of the memory initialization operations. In some aspects, the first thread 592 (thread 1) may send multiple DM poll messages to the second thread 594 (thread 2) to determine if the memory has been enabled. One or more of these subsequent DM poll messages may occur after or during performance of run time initialization operations (e.g., RCINIT operations). To illustrate, as the memory may require 178 microseconds to clean and initialize in some examples, such as for an 8 MB cache memory for a low power audio subsystem, the second thread 594 (thread 2) may not finish its clean-up end until after start of the run time initialization, that is after earlier run time initialization (e.g., RCINIT) start at 590 in the example of FIG. 5.

At 530, the second thread 594 (thread 2) completes the memory clean-up and initialization operations. For example, the second thread 594 (thread 2) may respond to the DM poll message with a DM poll response message or acknowledgment message indicating completion of the memory initialization operations, and optionally the prior clean-up operations. The DM poll response message or acknowledgment message may indicate the memory is enable and ready for use, such as ready for use in the run time initialization processes and/or after completion of the quick boot process at 538. As described above, multiple DM poll response messages may be sent in some aspects where multiple DM poll messages are sent.

At 532, the first thread 592 (thread 1) performs run time initialization loop operations. For example, the first thread 592 (thread 1) may perform run time initialization operations, at 534, for multiple run time initialization groups (e.g., RCINIT groups) in parallel. To illustrate, the first thread 592 (thread 1) may perform run time initialization operations at 534, such as transmit initialization messages to one or more run time initialization groups to engage in run time initialization operations and wait for completion of the various run time initialization processes by the one or more run time initialization groups (e.g., by separate RCINIT threads or the first thread 592 (thread 1)). The first thread 592 (thread 1) may determine the run time initialization operations for a particular group are completed responsive to receiving an acknowledgment or completion message from the particular group in response to its initialization message at 536.

After performing (e.g., coordinating or initializing) the run time initialization operations, at 534, the first thread 592 (thread 1) process may loop back to 532 to perform additional run time initialization operations and/or to wait for acknowledgement messages or run time initialization completion messages from each of the run time initialization groups.

After verification of completion of the run time initialization operations by received notifications, the quick boot operation is ended at 538. For example, the quick boot process may be completed by the SoC, or the processor thereof, as described with reference to FIG. 2 or with reference to 416 of FIG. 4. In some aspects, the memory has not been used (or used by the subsystem being quick booted) until this point, and the memory is now ready for use by the subsystem and/or the processor for the subsystem.

As illustrative examples, the processor may include or correspond to a core or multiple cores of a CPU of the SoC, and the subsystem may include or correspond to a digital signal processor of the SoC, an audio system of the SoC, a safety system of the SoC, a wireless communication system, of the SoC, etc. The memory may include or correspond to an internal or cache memory of the processor or the subsystem, or to an external memory or cache for the processor or subsystem which does not have a dedicated memory controller separate from the processor. In some aspects, multiple memories by cleaned an initialized as part of the quick boot process.

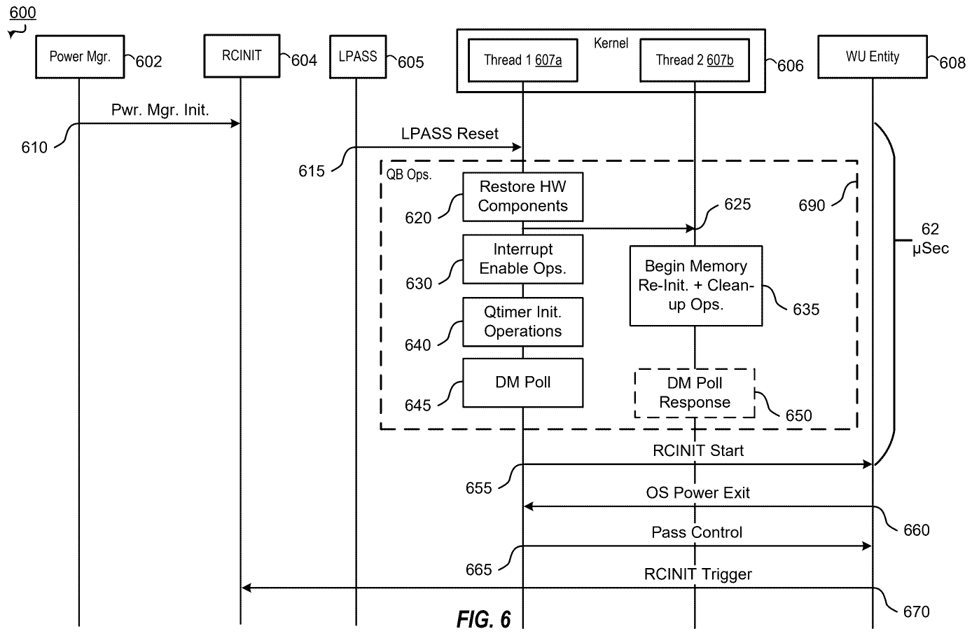

Referring to FIG. 6, FIG. 6 is an example of enhanced memory clean-up operations for SoCs, such as the SoC 301 of FIG. 3. In FIG. 6, a flow chart 600 illustrates enhanced memory restoration operations for SoCs according to some embodiments of the disclosure. In some implementations, the enhanced memory clean-up operations may be performed by the SoC, and any components thereof, of FIGS. 2-5. For example, the components of the SoCs of FIGS. 2-5 may perform memory clean-up operations. To illustrate, a first hardware (processor) thread and a second hardware (processor) thread of a processor may perform the operations illustrated in FIG. 6. The threads, thread 1 and thread 2, as illustrated in FIG. 6 may belong to a same, single core of the processor or to different cores of the processor.

As compared to the memory clean-up operations of FIG. 2, the enhanced memory clean-up operations of FIG. 6. get to an earlier run time initialization start, and the run time initialization operations can begin and end earlier. The earlier completion of the run time initialization operations completes the quick boot operation earlier and enables earlier use of the memory and earlier operation of the subsystem. Additionally, as the memory was cleaned and initialized, the subsystem will operate with a memory that has maintained data integrity, which reduces errors.

The SoC of FIG. 6 includes similar subsystems and components described with reference to the SoC of FIG. 2. Additionally, the SoC of FIG. 6 includes a multiple core CPU, such as CPU 316 of FIG. 3, that is configured to perform multiple operations of the quick boot process in parallel.

During operation of the SoC, at 610, the power manager 602 transmits an initialization signal to a run time controller. For example, the power manager 602 transmits a power management initialization transmission to a run time initializer, such as RCINIT 604 as illustrated in FIG. 6, and as described with reference to the transmission of the initialization signal at 210 of FIG. 2. The initialization signal (e.g., power management initialization transmission) may be configured to trigger start of a wake-up process from a sleep state. For example, the initialization signal (e.g., power management initialization transmission) may be configured to trigger a reset signal for a subsystem, such as a low power audio subsystem (LPASS) 605, which may be referred to as triggering a boot operation. The boot operation may include quick boot operation or a warm boot operation, or any other resume operation from a sleep state, such as deep sleep state. In the example of FIG. 6, the initialization signal triggers a parallelized quick boot sequence, and an example quick boot sequence is illustrated by the operations performed at 620-645 in box 690.

In the example of FIG. 6, the quick boot operation starts with an initialization signal from the power manager 602 to the RCINIT 604, which triggers a subsystem reset and a quick boot sequence steps by the operating system kernel, kernel 606, shown in box 690 and performed in parallel by multiple threads of a processor.

At 615, the LPASS 605 sends a reset signal to the kernel 606 (e.g., an operating system (OS)). For example, the LPASS 605 sends a subsystem reset signal to a processor, such as the CPU of a SoC, based on and/or responsive to the initialization signal being sent and/or received at the RCINIT 604 at 610, as described with reference to the transmission of the reset signal at 215 of FIG. 2. Although not illustrated in FIG. 6 for clarity, the power manager 602 and/or the RCINIT 604 may send a message or signal to the LPASS 605 to trigger the sending of the reset signal. In some implementations, the reset signal includes or corresponds to a quick boot, warm boot, or resume signal.

Responsive to receiving the reset signal from the LPASS 605, the kernel 606 performers a quick boot sequence (or other resume sequence) as illustrated in box 690 with multiple threads and at least partially in parallel. The kernel 606 is implemented by two or more threads on a single processor (e.g., one or more cores of a multi-core processors) and the two or more threads concurrently perform one or more of wake-up operations, notification operations, and memory clean-up and initialization operations for an associated memory, not shown in FIG. 6. The memory includes or correspond to a memory without a dedicated controller, such as an internal cache memory to the processor or a tightly coupled memory for the processor, such as a vTCM.

As illustrated in the example of FIG. 6, at 620, the first thread (thread 1 607a) operations to restore hardware components. For example, the first thread (thread 1 607a) performs actions to bring various hardware components that are associated with the LPASS 605 from a resume or sleep state, similar to the hardware restoration operations performed at 220 of FIG. 2. To illustrate, the first thread (thread 1 607a) may activate, start, or restore one or more interrupt controllers, such as a second-level vector interrupt controller (L2VIC), and power rails, such logic, memory, subsystem and/or oscillator power rails, system timers, such as subsystem timers or related subsystem timers, or any combination thereof.

At 625, the first thread (thread 1 607a) performs DMA interrupt operations. For example, the first thread (thread 1 607a) may send a DMA start message to the second thread (thread 2 607b), which includes or is acting as a DMA engine for the memory. As another example, the DMA start message may configure or cause the second thread (thread 2 607b) to load, function as, or otherwise performs the operations of the DMA engine.

At 630, the first thread (thread 1 607a) performs timer initialization operations. For example, the first thread (thread 1 607a) performs initializes one or more timers that are associated with the LPASS 605, such as with the operation thereof, and/or the boot sequence for resuming the LPASS 605. To illustrate, the first thread (thread 1 607a) may set and start one or more timers related to the LPASS 605 and/or may set and start one or more timers related the boot sequence for resuming the LPASS 605. The first thread (thread 1 607a) may use a Qtimer framework for setting the timers and based on quick boot sequence timer configuration information.

At 640, the first thread (thread 1 607a) performs interrupt enable operations. For example, the first thread (thread 1 607a) performs one or more interrupt operations related to the LPASS 605. The one or more interrupt operations may include hardware interrupts, software interrupts, or a combination thereof. To illustrate, the first thread (thread 1 607a) sends one or more interrupt request (IRQs) to components related to the LPASS 605 and resuming the LPASS 605. These interrupts may include one or more interrupts associated with entering the sleep state. For example, the interrupts that were enabled for entering the sleep state are disabled.

At 635, the second thread (thread 2 607b) performs memory clean-up and initialization operations in parallel with quick boot sequence operations performed by the first thread (thread 1 607a). For example, the second thread (thread 2 607b), such as the DMA engine thereof, performs operations on the memory to maintain data integrity and prepare the memory for use by the subsystem. To illustrate, the second thread (thread 2 607b) disables the memory, cleans-up the memory, and enables the memory. In some aspects where the memory is an ECC mode or operating in an ECC mode, the second thread (thread 2 607b) may additionally enable ECC for the memory. Disabling the memory may include writing control bits configured to disable the memory, such as to the cache lines or register control space. Enabling ECC may include setting an ECC flag or control bits. Cleaning-up and/or initializing the memory may include preparing the memory, and blocks/lines thereof, for use. This may include writing a bit value, e.g., a logic low or 0, to each of them. When ECC is involved the clean-up and initializing may include writing bit values to the ECC meta data region. To enable the memory, the second thread (thread 2 607b) may write enabling control bits to the memory, cache lines or control register space, to enable use of the memory again. As illustrated in FIG. 6, the second thread (thread 2 607b) begins the memory clean-up and initialization operations at 635. However, the second thread (thread 2 607b) may complete the memory clean-up and initialization operations before or after run time initialization start, such as depending on the size of the memory to be cleaned.

At 645, the first thread (thread 1 607a) performs a polling operation on the second thread (thread 2 607b) for a status of the DMA engine and/or memory initialization operations. For example, the first thread (thread 1 607a) may send a DM poll message to the second thread (thread 2 607b) to determine if the memory has been enabled at or after the completion of the memory initialization operations.

At 650, the second thread (thread 2 607b) performs a DM poll response operation. For example, the second thread (thread 2 607b) transmits a DM poll response in response to receiving the DM poll message or responsive to the DM poll message at 645, and in response to completion of the memory clean-up and initialization operations at 635. Although the DM poll response is illustrated as being performed prior to run time initialization start operations at 655, in some examples the DM poll response may occur after run time initialization start operations in addition to or in the alternative of being performed prior to run time initialization start operations. For example, for a similar subsystem with a similar memory size, the memory initialization and clean-up operations may take 178 μs to complete and may complete after run time initialization start operations. In some such operations, the threads may perform run time initialization start operations in parallel with memory initialization and/or clean-up operations, in addition to the memory initialization and clean-up operations being performed in parallel with the wake up and quick boot notification operations.

At 655, the kernel 606 performs run time initialization start operations. For example, the kernel 606 (e.g., the first thread, the second thread, a third thread, or any combination thereof) sends a run time initialization start indication to the wake-up entity 608 to start run time initialization operations responsive to completion of the quick boot sequence by the kernel 606, i.e., responsive to a DM poll response at 645 indicating the completion of the memory clean-up and initialization operations by the second thread (thread 2 607b).

As compared to the example of FIG. 2, the example of FIG. 6 has an earlier run time initialization start due to parallelization of the quick boot process. In some examples, the performance of the memory clean-up and initialization operations may still take 178 μs. However, in the example of FIG. 6, the total time from quick boot start until run time initialization (e.g., RCINIT) start for the LPASS 605 is only 62 μs and down from 240 μs for FIG. 2, that is from initialization by the power manager 202 at 210 to the run time initialization start at 655 (e.g., the transmission of a RCINIT start message at 655). This reduction in time may reduce the overall quick boot time by 178 μs because the run time initialization can start and finish earlier, and even continue in parallel with the memory operations.

At 660, the wake-up entity 608 (WU Entity) sends an operating system power exit trigger to the kernel 606 to enable termination of the operating system. For example, the wake-up entity 608 (WU Entity) sends an operating system power exit message to the kernel 606 to enable termination of the quick boot sequence operating system based on and/or responsive to receiving the run time initialization start indication at 655 and/or determining a run time initialization start trigger.

At 665, the kernel 606 passes quick boot operational control to the wake-up entity 608 (WU Entity). For example, the kernel 606 sends a control transfer indication or message to the wake-up entity 608 to provide or pass control to the wake-up entity 608 based on and/or responsive to receiving the operating system power exit message or indication at 660 and/or determining a quick boot operational control trigger.

At 670, the wake-up entity 608 (WU Entity) sends a run time initialization operation trigger indication to the RCINIT 604 to trigger run time initialization operations for run time initialization groups. For example, the wake-up entity 608 (WU Entity) sends run time initialization operation trigger message to the RCINIT 604 to trigger run time initialization operations for multiple run time initialization groups of or associated with the LPASS 605 based on and/or responsive to being passed control at 665. The run time initialization operations for the multiple run time initialization groups (e.g., the operations performed by the groups) may be performed in parallel.

After 670, the RCINIT 604 performs run time initialization operations for run time initialization groups and receives notifications of completion of the run time initialization operations. The quick boot process ends upon competition of the run time initialization operations for each of the run time initialization groups, and upon completion of the quick boot process, the memory is usable. For example, the memory (e.g., cache or vTCM) is usable by the LPASS 605 and/or by the processor for the subsystem. The memory is also usable for other subsystems, such as by the processor for the other subsystems.

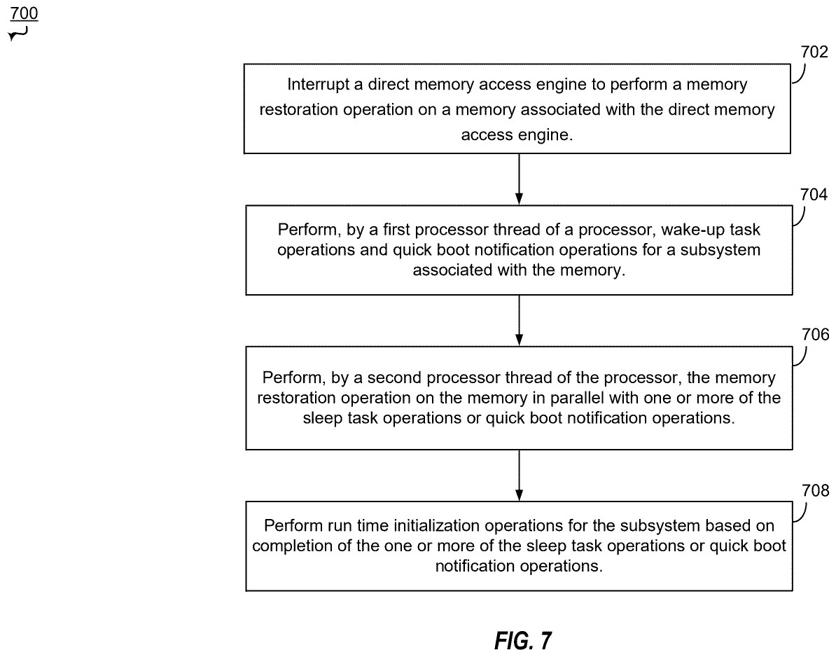

Referring to FIG. 7, FIG. 7 is a flow chart illustrating a method 700 for enhanced memory restoration operations according to some embodiments of the disclosure. In some implementations, the method may be performed by any of the SoCs, and components thereof, of FIGS. 2-8. For example, the components of the SoCs of FIGS. 2-8 may perform enhanced memory clean-up operations.

The method 700 includes, at block 702, interrupting a direct memory access engine to perform a memory restoration operation on a memory associated with the direct memory access engine. For example, the first thread, such as thread 1 607a, sends an interrupt signal to the second thread, such as thread 2 607b, and a direct memory access engine thereof to perform memory clean-up and initialization operations on the memory associated with the direct memory access engine. Examples of interrupt operations are described with reference to FIG. 206. The memory may be associated with the processor and/or the subsystem or may be associated with another processor and/or the subsystem, and may correspond to any of the memories of FIGS. 2-6.

At block 704, the method 700 includes performing, by a first processor thread of a processor of the SoC, wake-up task operations and quick boot notification operations for a subsystem associated with the memory. For example, the first thread, such as thread 1 607a, performs wake-up task operations and quick boot notification operations for the subsystem associated with the memory, as described with reference to FIGS. 2-6. To illustrate, the first thread, such as thread 1 607a, may transmit signals to bring hardware components online, restore hardware configurations, inform other components for the quick boot processor, etc., or any combination thereof.

At block 706, the method 700 includes performing, by a second processor thread of the processor, the memory restoration operation on the memory in parallel with one or more of the wake-up task operations or quick boot notification operations. For example, the second thread, such as thread 2 607b, performs memory clean-up operations, memory initialization operations, or a combination thereof, on the memory in parallel with one or more of the wake-up task operations or quick boot notification operations by the first thread, such as thread 1 607a, as described with reference to FIGS. 2-6. To illustrate, the second thread, such as thread 2 607b, may perform the memory restoration operations described with reference to FIG. 4, including one or more of disabling the memory, cleaning up the memory, and enabling the memory.

At block 708, the method 700 includes performing run time initialization operations for the subsystem based on completion of the one or more of the wake-up task operations or quick boot notification operation. For example, the first thread, such as thread 1 607a, performs run time initialization operations for the subsystem based on completion of the one or more of the wake-up task operations or quick boot notification operation, as described with reference to FIGS. 2-6. To illustrate, the first thread, such as thread 1 607a, may perform the run time initialization operations for the subsystem based on completion of the one or more of the wake-up task operations or quick boot notification operation and independent of the completion of the memory clean-up and initialization operations on the memory by the second thread, such as thread 2 607b. In some such examples, the first thread, such as thread 1 607a, performs the run time initialization operations, such as RCINIT instruction, in parallel with the memory clean-up and initialization operations performed by the second thread, such as thread 2 607b.

Accordingly, a SoC may perform enhanced memory restoration operations. By performing enhanced memory restoration operations, such as with parallelization of one or more operations of a quick boot process, quick boot process latency and memory failures may be reduced, and the SoC may provide a better overall user experience. Additionally, the reduced latency and memory failures may increase system safety and reduce power consumption by enabling systems, even safety system, critical systems, or systems with low latency requirements, to be powered down more often because of the faster resume from quick boot.

In a first aspect, a system-on-chip (SoC) includes at least one processor and a memory coupled to the at least one processor. The at least one processor is configured to cause the SoC to: interrupt a direct memory access engine to perform a memory restoration operation on a memory associated with the direct memory access engine; perform, by a first processor thread of a processor of the at least one processor, wake-up task operations and quick boot notification operations for a subsystem associated with the memory; perform, by a second processor thread of the processor, the memory restoration operation on the memory in parallel with one or more of the wake-up task operations or quick boot notification operations; and perform run time initialization operations for the subsystem based on completion of the one or more of the wake-up task operations or quick boot notification operation.

In a second aspect, alone or in combination with the first aspect, the memory includes layer 2 cache memory or vector tightly coupled memory (vTCM) for the processor. The processor may include or correspond to a processor of the SoC or of the subsystem being quick booted, such as a compute subsystem, and audio subsystem, a modem, a DSP subsystem, etc. In one particular example, the processor is or includes the processor with the first and second threads.

In a third aspect, alone or in combination with one or more of the above aspects, the processor includes the direct memory access engine, and the direct memory access engine is configured to control operations of the memory, and wherein the memory does not have a dedicated memory controller.

In a fourth aspect, alone or in combination with one or more of the above aspects, the first and second processor threads are part of the same core or different cores of the processor.

In a fifth aspect, alone or in combination with one or more of the above aspects, the at least one processor configured to cause the SoC to perform, by the second processor thread, the memory restoration operation includes to: disable the memory by writing first control bits to the memory; enable ECC for the memory by writing control information to an ECC control space of the memory; clean-up the memory by writing reset bits to the memory; and enable to memory by writing second control bits to the memory.

In a sixth aspect, alone or in combination with one or more of the above aspects, the subsystem is a digital signal processor.

In a seventh aspect, alone or in combination with one or more of the above aspects, the subsystem is an audio system, a safety system, a modem, a compute subsystem, a wireless communication subsystem (e.g., a WLAN subsystem), a neural signal processor (NSP) subsystem, or a sensor subsystem.

In an eighth aspect, alone or in combination with one or more of the above aspects, the memory restoration operation includes one or more memory clean-up operations, and the one or more memory clean-up operations include writing a bit value to each cache line of a plurality of cache lines.

In a ninth aspect, alone or in combination with one or more of the above aspects, the memory restoration operation includes one or more memory initialization operations, and the one or more memory initialization operations include writing a second bit value (e.g., a reset value, such as all zeros or all ones) to each cache line of a plurality of cache lines.

In a tenth aspect, alone or in combination with one or more of the above aspects, the at least one processor is further configured to cause the SoC to: enter, prior to the interruption of the direct memory access engine, a deep sleep mode, a suspend to random access memory (RAM) (STR) state, or another sleep state where the memory is powered down; determine a wake-up indication for the subsystem; and perform a quick boot operation for the subsystem responsive to the wake-up indication.

In an eleventh aspect, alone or in combination with one or more of the above aspects, the at least one processor is further configured to cause the SoC to: restore, by the first processor thread of the processor, hardware components associated with the subsystem; and initialize, by the first processor thread of the processor, one or more timers and interrupts associated with the subsystem.

In a twelfth aspect, alone or in combination with one or more of the above aspects, the at least one processor is further configured to cause the SoC to: store, by the first processor thread of the processor, a start address and an address range of the memory to be cleaned, wherein the at least one processor is further configured to cause the SoC to interrupt the direct memory access engine includes to: send, by the first processor thread of the processor, a DM start message to the second processor thread and indicating the start address and the address range of the memory to be cleaned.

In a thirteenth aspect, alone or in combination with one or more of the above aspects, the at least one processor configured to cause the SoC to perform the wake-up task operations and the quick boot notification operations for the subsystem associated with the memory includes to: perform, by the first processor thread of the processor, the wake-up task operations; and perform, by the first processor thread of the processor, the quick boot notification operations responsive to completion of the wake-up task operations, wherein the run time initialization operations are performed responsive to completion of the quick boot notification operations.

In a fourteenth aspect, alone or in combination with one or more of the above aspects, the at least one processor is further configured to cause the SoC to: perform the run time initialization operations in parallel with the memory restoration operation.

In a fifteenth aspect, alone or in combination with one or more of the above aspects, the at least one processor is further configured to cause the SoC to: transmit, by the first processor thread to the second processor thread, a direct memory poll request that requests a status of the memory restoration operation; receive, by the first processor thread from the second processor thread, a direct memory poll request response indicating completion of the memory restoration operation.

In a sixteenth aspect, alone or in combination with one or more of the above aspects, the at least one processor configured to cause the SoC to perform the run time initialization operations includes to: start, by the first processor thread of the processor, a plurality of run time initialization processes for a plurality of run time initialization groups; perform, by one or more run time initialization threads, a corresponding run time initialization process for each run time initialization group of the plurality of run time initialization groups; and notify, by the one or more run time initialization threads, the processor upon completion of the run time initialization processes for each run time initialization group of the plurality of run time initialization groups; and wherein the at least one processor is further configured to cause the SoC to: complete the quick boot operation responsive to receiving notifications for each run time initialization group of the plurality of run time initialization groups; and begin using the memory after completion of the quick boot operation.

In a seventeenth aspect, alone or in combination with one or more of the above aspects, the SoC or the processor is not in a sleep state during the quick boot operations.

In an eighteenth aspect, alone or in combination with one or more of the above aspects, the wake-up tasks operations include restoring hardware and hardware configurations, and wherein the quick boot notification operations include notifying components of the subsystem or other subsystem via system message or interrupts.

In a nineteenth aspect, alone or in combination with one or more of the above aspects, a method for enhanced deep sleep for a system-on-chip (SoC) includes: interrupting a direct memory access engine to perform a memory restoration operation on a memory associated with the direct memory access engine; performing, by a first processor thread of a processor of the SoC, wake-up task operations and quick boot notification operations for a subsystem associated with the memory; performing, by a second processor thread of the processor, the memory restoration operation on the memory in parallel with one or more of the wake-up task operations or quick boot notification operations; and performing run time initialization operations for the subsystem based on completion of the one or more of the wake-up task operations or quick boot notification operation.

In a twentieth aspect, alone or in combination with one or more of the above aspects, a system-on-chip (SoC) includes: at least one processor; and a memory coupled to the at least one processor. The at least one processor is configured to cause the SoC to: transmit, by a first processor thread of a processor of the at least one processor to a second processor thread of the processor, a direct memory start indication that indications for a direct memory access engine to perform a memory restoration operation on a memory associated with the direct memory access engine; perform, by the first processor thread, wake-up task operations for a subsystem associated with the memory; perform, by the first processor thread, quick boot notification operations for the subsystem; transmit, by the first processor thread to the second processor thread, a direct memory poll request that requests a status of the memory restoration operation; receive, by the first processor thread from the second processor thread, a direct memory poll request response indicating completion of the memory restoration operation; and perform run time initialization operations in parallel with the memory restoration operation.

In a twenty-first aspect, alone or in combination with one or more of the above aspects, a system-on-chip (SoC) includes: at least one processor; and a memory coupled to the at least one processor. The at least one processor is configured to cause the SoC to: receive, by a first processor thread of a processor of the at least one processor from a second processor thread of the processor, a direct memory start indication that indications for a direct memory access engine to perform a memory restoration operation; perform, by the first processor thread, the memory restoration operation; receive, by the first processor thread from the second processor thread, a direct memory poll request that requests a status of the memory restoration operation; and transmit, by the first processor thread to the second processor thread, a direct memory poll request response indicating completion of memory restoration operation.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and “back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A system-on-chip (SoC), comprising:
at least one processor; and
a memory coupled to the at least one processor,
wherein the at least one processor is configured to cause the SoC to:
interrupt a direct memory access engine to perform a memory restoration operation on a memory associated with the direct memory access engine;
perform, by a first processor thread of a processor of the at least one processor, wake-up task operations and quick boot notification operations for a subsystem associated with the memory;
perform, by a second processor thread of the processor, the memory restoration operation on the memory in parallel with one or more of the wake-up task operations or quick boot notification operations; and
perform run time initialization operations for the subsystem based on completion of the one or more of the wake-up task operations or quick boot notification operation.

2. The SoC of claim 1, wherein the memory includes layer 2 cache memory or vector tightly coupled memory (vTCM) for the processor.

3. The SoC of claim 1, wherein the processor includes the direct memory access engine, and the direct memory access engine is configured to control operations of the memory, and wherein the memory does not have a dedicated memory controller.

4. The SoC of claim 3, wherein the first and second processor threads are part of the same core or different cores of the processor.

5. The SoC of claim 1, wherein the at least one processor configured to cause the SoC to perform, by the second processor thread, the memory restoration operation includes to:
disable the memory by writing first control bits to the memory;
enable error correction control (ECC) for the memory by writing control information to an ECC control space of the memory;
clean-up the memory by writing reset bits to the memory; and
enable to memory by writing second control bits to the memory.

6. The SoC of claim 1, wherein the subsystem is a digital signal processor.

7. The SoC of claim 6, wherein the subsystem is an audio system, a safety system, a modem, a compute subsystem, a wireless communication subsystem, a neural signal processor (NSP) subsystem, or a sensor subsystem.

8. The SoC of claim 6, wherein the memory restoration operation includes one or more memory clean-up operations, and wherein the one or more memory clean-up operations include writing a bit value to each cache line of a plurality of cache lines.

9. The SoC of claim 1, wherein the memory restoration operation includes one or more memory initialization operations, and wherein the one or more memory initialization operations include writing a second bit value to each cache line of a plurality of cache lines.

10. The SoC of claim 1, wherein the at least one processor is further configured to cause the SoC to:
enter, prior to the interruption of the direct memory access engine, a deep sleep mode, a suspend to random access memory (RAM) (STR) state, or another sleep state where the memory is powered down;
determine a wake-up indication for the subsystem; and
perform a quick boot operation for the subsystem responsive to the wake-up indication.

11. The SoC of claim 1, wherein the at least one processor is further configured to cause the SoC to:
restore, by the first processor thread of the processor, hardware components associated with the subsystem; and
initialize, by the first processor thread of the processor, one or more timers and interrupts associated with the subsystem.

12. The SoC of claim 11, wherein the at least one processor is further configured to cause the SoC to:
store, by the first processor thread of the processor, a start address and an address range of the memory to be cleaned, wherein the at least one processor is further configured to cause the SoC to interrupt the direct memory access engine includes to:
send, by the first processor thread of the processor, a DM start message to the second processor thread and indicating the start address and the address range of the memory to be cleaned.

13. The SoC of claim 1, wherein the at least one processor configured to cause the SoC to perform the wake-up task operations and the quick boot notification operations for the subsystem associated with the memory includes to:
perform, by the first processor thread of the processor, the wake-up task operations; and
perform, by the first processor thread of the processor, the quick boot notification operations responsive to completion of the wake-up task operations, wherein the run time initialization operations are performed responsive to completion of the quick boot notification operations.

14. The SoC of claim 13, wherein the at least one processor is further configured to cause the SoC to:
perform the run time initialization operations in parallel with the memory restoration operation.

15. The SoC of claim 1, wherein the at least one processor is further configured to cause the SoC to:
transmit, by the first processor thread to the second processor thread, a direct memory poll request that requests a status of the memory restoration operation; and
receive, by the first processor thread from the second processor thread, a direct memory poll request response indicating completion of the memory restoration operation.

16. The SoC of claim 1, wherein the at least one processor configured to cause the SoC to perform the run time initialization operations includes to:
start, by the first processor thread of the processor, a plurality of run time initialization processes for a plurality of run time initialization groups;
perform, by one or more run time initialization threads, a corresponding run time initialization process for each run time initialization group of the plurality of run time initialization groups; and
notify, by the one or more run time initialization threads, the processor upon completion of the run time initialization processes for each run time initialization group of the plurality of run time initialization groups; and wherein the at least one processor is further configured to cause the SoC to:
complete a quick boot operation responsive to receiving notifications for each run time initialization group of the plurality of run time initialization groups; and
begin using the memory after completion of the quick boot operation.

17. The SoC of claim 16, wherein the SoC or the processor is not in a sleep state during the quick boot operation.

18. The SoC of claim 1, wherein the wake-up tasks operations include restoring hardware and hardware configurations, and wherein the quick boot notification operations include notifying components of the subsystem or other subsystem via system message or interrupts.

19. A method for enhanced deep sleep for a system-on-chip (SoC), the method comprising:
interrupting a direct memory access engine to perform a memory restoration operation on a memory associated with the direct memory access engine;
performing, by a first processor thread of a processor of the SoC, wake-up task operations and quick boot notification operations for a subsystem associated with the memory;
performing, by a second processor thread of the processor, the memory restoration operation on the memory in parallel with one or more of the wake-up task operations or quick boot notification operations; and
performing run time initialization operations for the subsystem based on completion of the one or more of the wake-up task operations or quick boot notification operation.

20. A system-on-chip (SoC), comprising:
at least one processor; and
a memory coupled to the at least one processor,
wherein the at least one processor is configured to cause the SoC to:
transmit, by a first processor thread of a processor of the at least one processor to a second processor thread of the processor, a direct memory start indication that indications for a direct memory access engine to perform a memory restoration operation on a memory associated with the direct memory access engine;
perform, by the first processor thread, wake-up task operations for a subsystem associated with the memory;
perform, by the first processor thread, quick boot notification operations for the subsystem;
transmit, by the first processor thread to the second processor thread, a direct memory poll request that requests a status of the memory restoration operation;
receive, by the first processor thread from the second processor thread, a direct memory poll request response indicating completion of the memory restoration operation; and
perform run time initialization operations in parallel with the memory restoration operation.
